(19) United States
(12) Patent Application Publication
(10) Pub. No.: US 2023/0289888 A1
(43) Pub. Date: Sep. 14, 2023

(54) SYSTEM FOR PROVIDING AN AUTOMATED ELECTRONIC HEALTHCARE INSURANCE PAYOR PLATFORM

(71) Applicant: Richard Bemis, Lakewood, CA (US)

(72) Inventor: Richard Bemis, Lakewood, CA (US)

(21) Appl. No.: 18/118,986

(22) Filed: Mar. 8, 2023

Related U.S. Application Data
(60) Provisional application No. 63/317,908, filed on Mar. 8, 2022.

(51) Int. Cl. G06Q 40/08

(52) U.S. Cl. CPC G06Q 40/08

(57) ABSTRACT

A system for providing a platform for automating healthcare insurance administration is disclosed, including at least one user computing device in operable connection with a user network. An application server is in operable communication with the user network to host an application system for providing a platform for automating healthcare insurance administration. The application system includes a user interface for providing access to the application system through the user computing device.

### TECHNICAL FIELD

The embodiments generally relate to computerized systems for automating healthcare payor administration.

### BACKGROUND

Healthcare payor business processes are complex and demanding. Regulatory requirements impact clinical and administrative processes used by multiple departments. Departments must manually re-classify data to process claims, manage provider directory, care delivery, utilization management, case management, benefit entitlements, open enrollment, and more. If not managed correctly, processing becomes error-prone and creates additional overhead and increases operational cost. Manual processes make it difficult to react to regulations, providers, members, and more. An efficient enterprise digital payor platform automates these processes and makes adapting to changing business and regulations easier.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments herein relate a system that provides a platform for automating healthcare insurance administration. The system includes at least one user computing device in operable connection with a user network. An application server is in operable communication with the user network to host an application system for providing a platform for automating healthcare insurance administration. The application system includes a user interface for providing access to the application system through the user computing device. The system provides an automated healthcare insurance payor platform. The system allows for claims management integration, provider data management, provider relations, provider directory, contract management for physicians, nurses, surgical technicians, ancillary providers, member management, care delivery encounters, benefits entitlement, better healthcare customer support, and reduces corrective actions plans. The system may also provide better patient outcomes, more accurate healthcare case management, intelligent reporting to health care agencies, better sharing of healthcare pandemic information, and reduced overhead for operations.

In the current arts, some limitations and disadvantages of current industry processes include; poor payment reconciliation, risk due to out of compliance provider directories, members traveling to the wrong address for care, time and distance standards are inaccurate, inaccurate information leading to grievances, inaccurate provider assignment to the patient, non-compliance in all aspects of payor administration, and increased member/provider support calls. The embodiments described herein relate to a system for providing a software platform for automating healthcare payor administration functions.

The system reduces the cost to the consumer, payor, and facilitates improved processes for data management and reporting in the healthcare insurance industry. This includes provider-to-contract, member-to-benefits, encounter-to-claims, and case/utilization management transactions. The system is a centralized healthcare insurance payor platform, automated processing center, and centralized data repository platform for structured and unstructured healthcare data. This may include provider data management as a service (PDMaaS), member assignment to a primary care physician, facility site review, intelligent claims coding (ICC), and intelligent provider directory (IPD). The system may utilize artificial intelligence, machine learning, data mastering methods, workflow, structured data, semi-structured data, and big data management to provide an automated platform solution for the healthcare payor industry. For this document, payor and payer are used interchangeably.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of a computing system, according to some embodiments;

FIG. 2A illustrates a block diagram of a portion of the system architecture, according to some embodiments;

FIG. 2B illustrates a block diagram of a portion of the system architecture, according to some embodiments;

FIG. 2C illustrates a block diagram of a portion of the system architecture, according to some embodiments;

FIG. 2D illustrates a block diagram of a portion of the system architecture, according to some embodiments;

FIG. 2E illustrates a block diagram of a portion of the system architecture, according to some embodiments;

FIG. 2F illustrates a block diagram of a portion of the system architecture, according to some embodiments;

FIG. 2G illustrates a block diagram of a portion of the system architecture, according to some embodiments;

FIG. 2H illustrates a block diagram of a portion of the system architecture, according to some embodiments; and

FIG. 2I illustrates a block diagram of a portion of the system architecture, according to some embodiments.

The drawings are not necessarily to scale, and certain features and certain views of the drawings may be shown exaggerated in scale or in schematic in the interest of clarity and conciseness.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, and/or computer program product at any possible technical detail level of integration. A computer program product can include, among other things, a computer-readable storage medium having computer-readable program instructions thereon for causing a processor to carry out aspects of the present disclosure.

In general, the embodiments provided herein relate to a system for providing a software platform for automating healthcare payor administration functions. The system reduces the cost to the consumer and insurer and facilitates improved processes and data management in the healthcare insurance industry. This includes provider-to-contract, member-to-benefits, encounter-to-claims, and case/utilization management transactions. The system is a centralized healthcare insurance payor platform, automated processing center, and centralized data repository platform for structured and unstructured healthcare data. This may include provider data management as a service (PDMaaS), member assignment to a primary care physician, facility site review, intelligent claims coding (ICC), and intelligent provider directory (IPD). This may include provider data management as a service (PDMaaS), member assignment to a primary care physician, facility site review, intelligent claims coding (ICC), and intelligent provider directory (IPD). The system may utilize artificial intelligence, machine learning, data mastering methods, workflow, structured data, semi-structured data, and big data management to provide an automated platform solution for the healthcare payor industry.

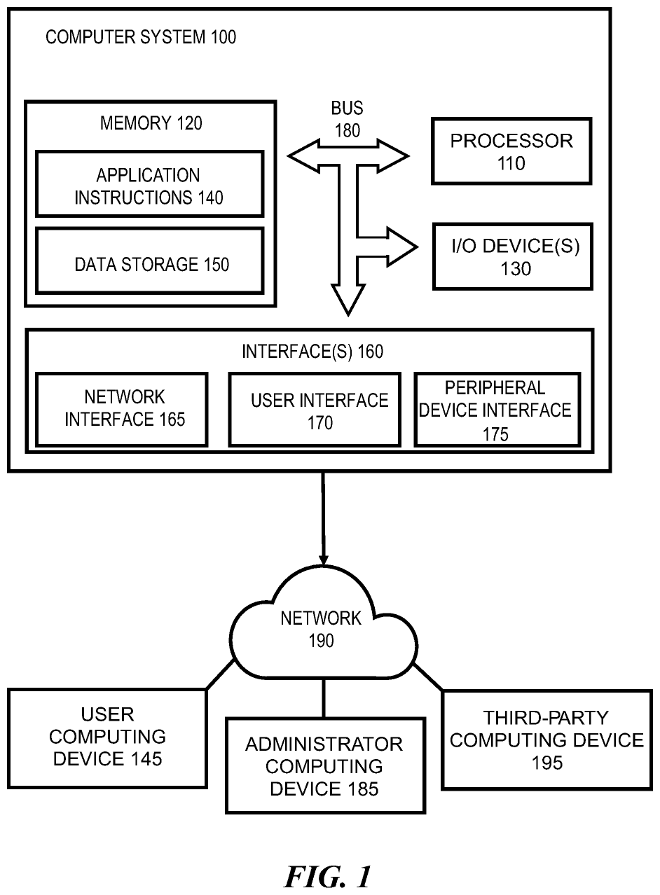

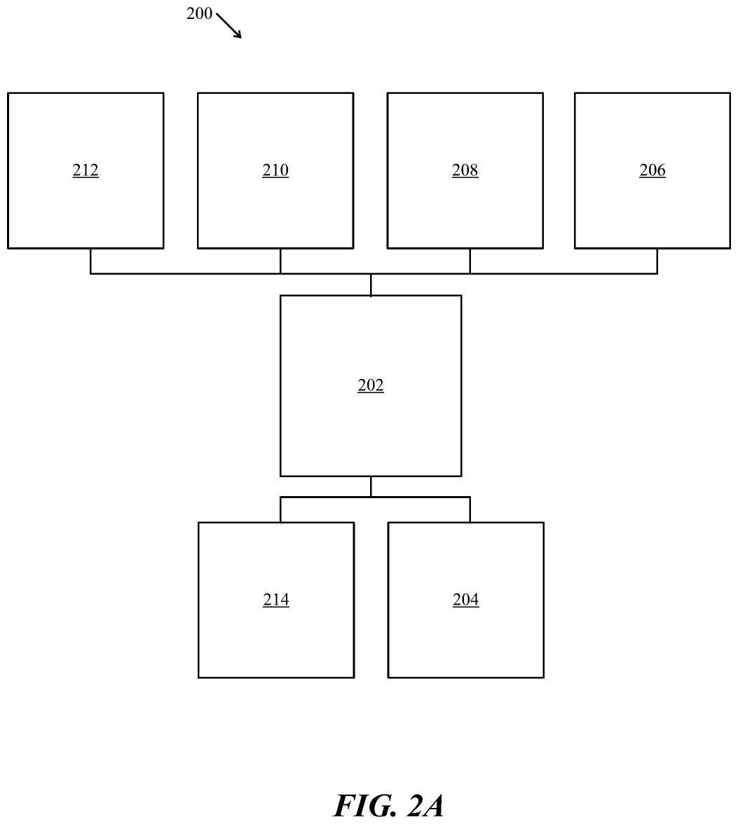

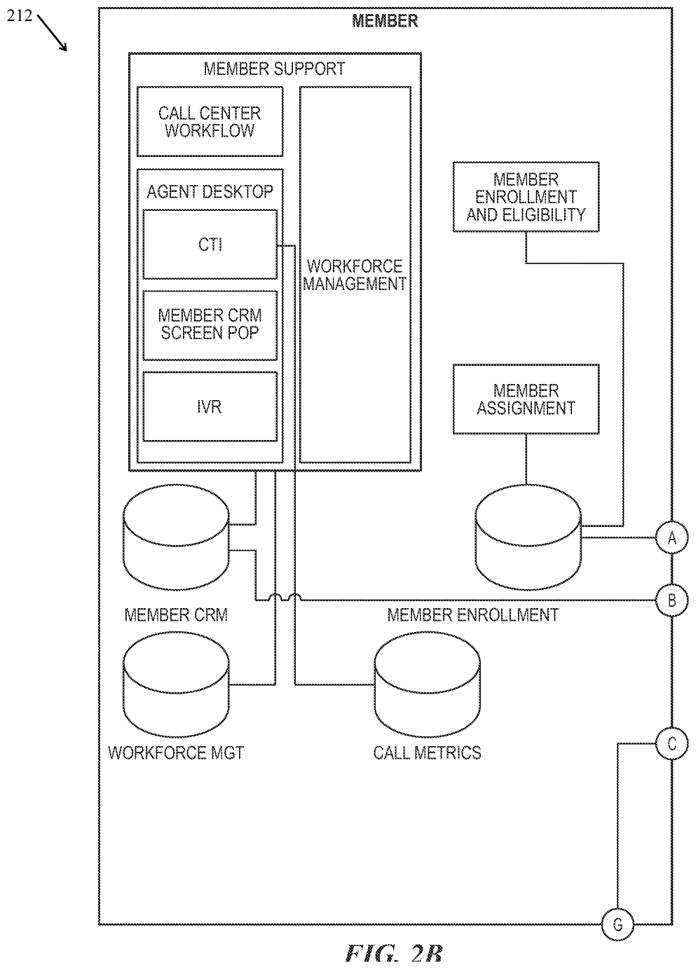

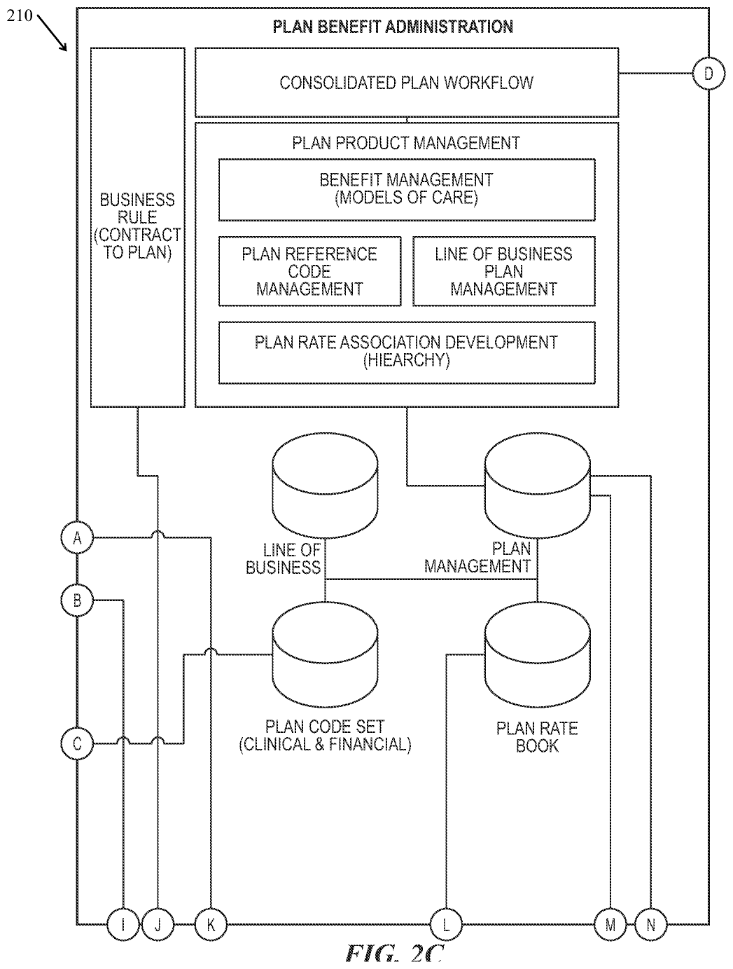

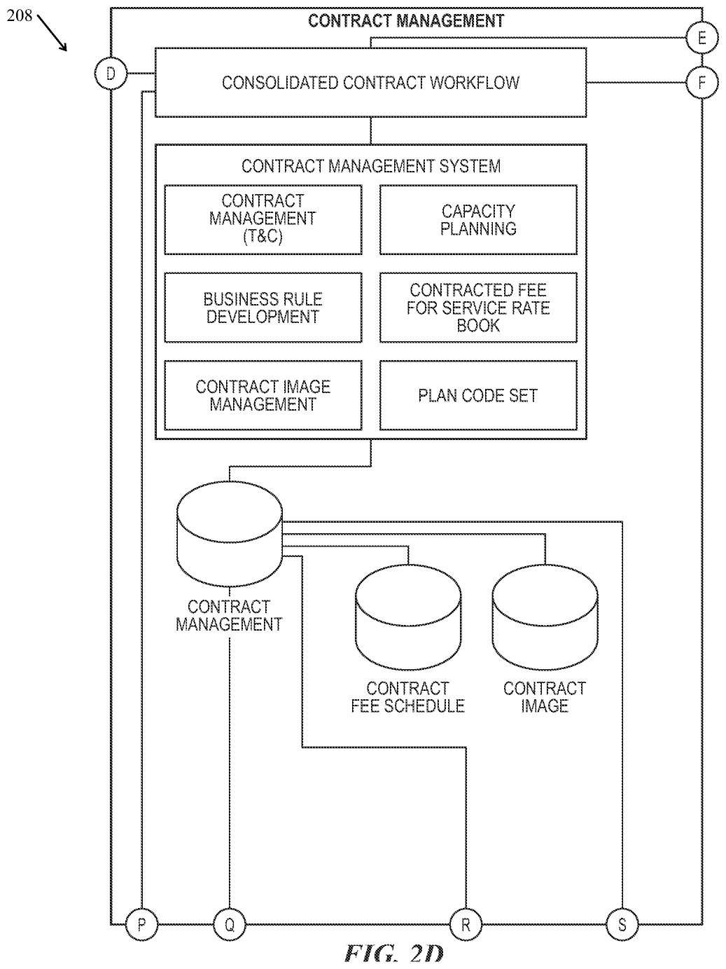

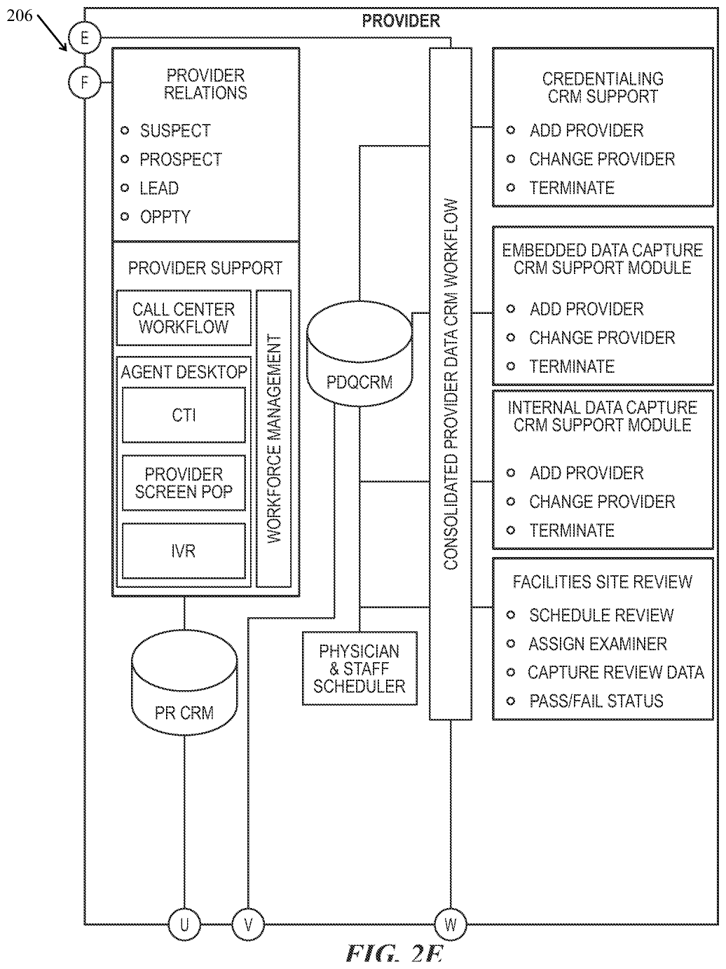

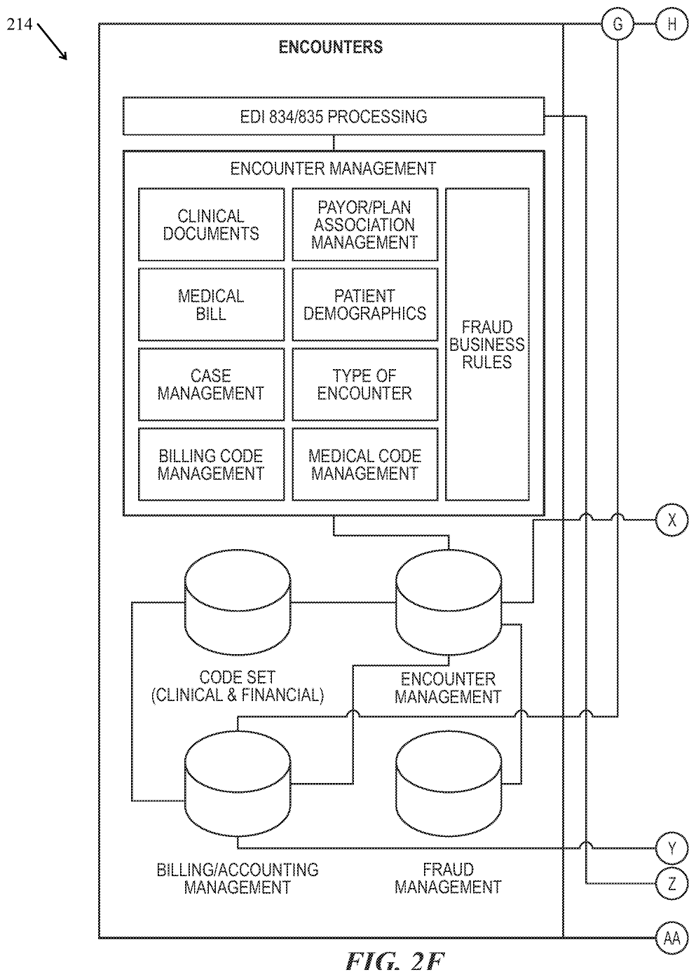

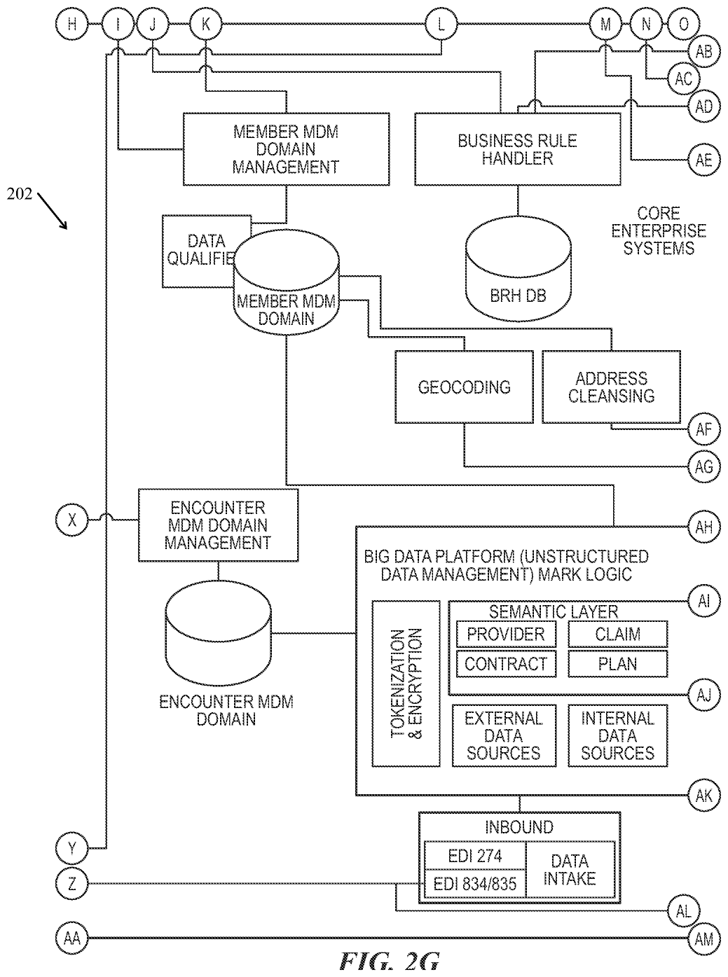

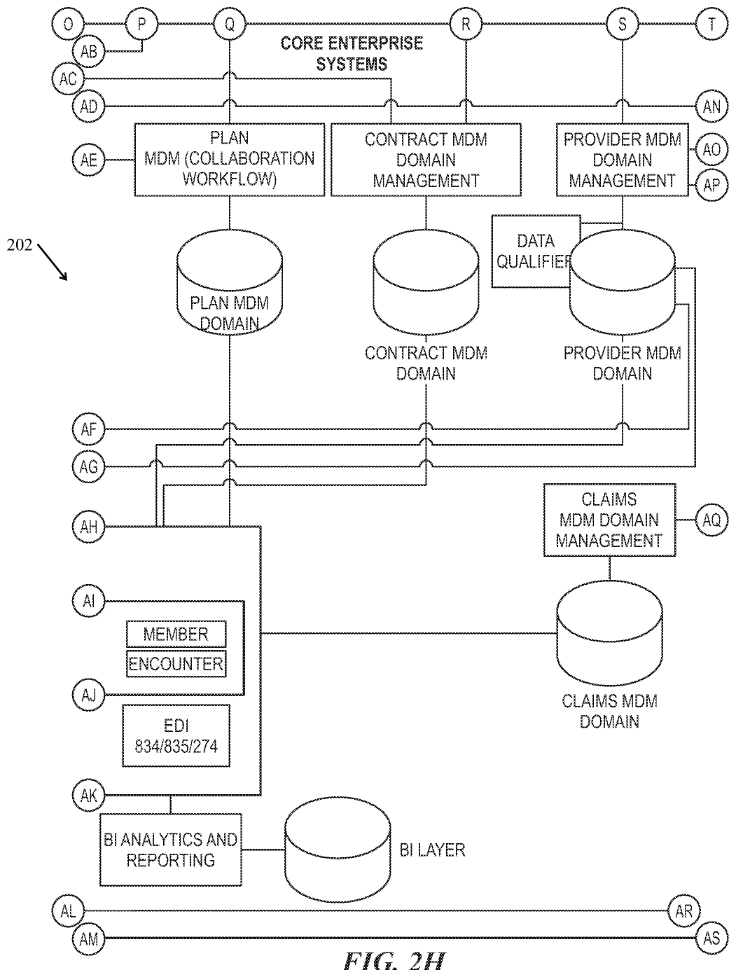

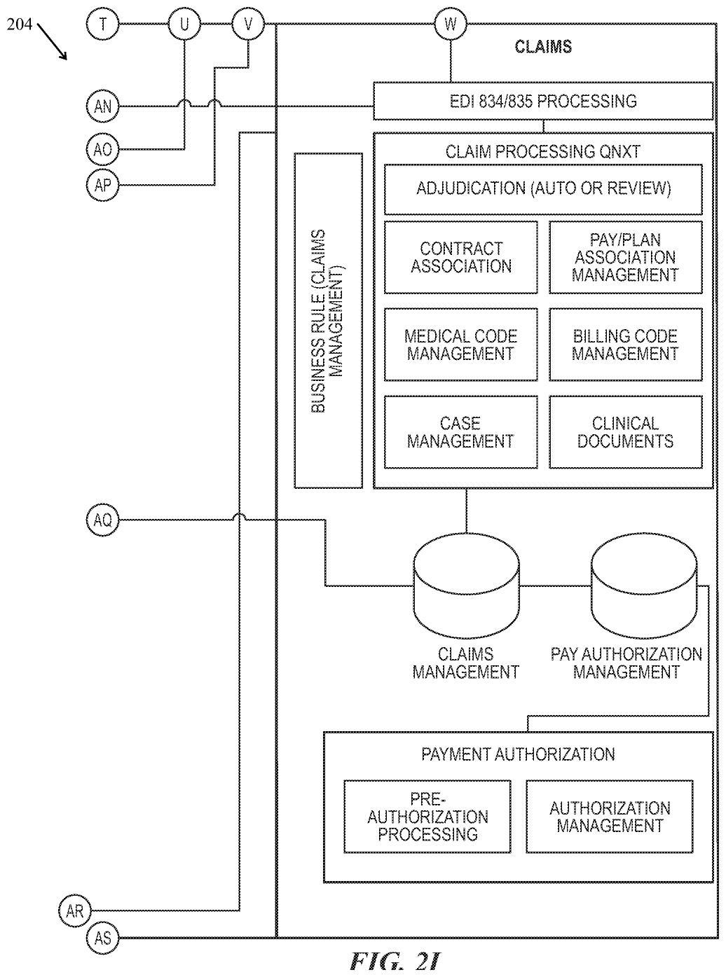

FIG. 1 illustrates an example of a computer system 100 (depicted as 200 in FIGS. 2A-2H) that may be utilized to execute various procedures, including the processes described herein. The computer system 100 comprises a cloud computing system, digital computing system, standalone computer or mobile computing device, a mainframe computer system, a workstation, a network computer, a desktop computer, a laptop, or the like. The computing device 100 can be embedded in another device, e.g., a mobile telephone, a network of multiple physical or virtual devices, a personal digital assistant (PDA), a mobile audio or video player, a game console, a Global Positioning System (GPS) receiver, cloud computing storage platform, or a portable storage device (e.g., a universal serial bus (USB) flash drive).

In some embodiments, the computer system 100 includes one or more processors 110 coupled to a memory 120 through a system bus 180 that couples various system components, such as input/output (I/O) device 130, to the processors 110. The bus 180 may be any of several types of bus structures including a memory bus or memory controller, a peripheral bus, and a local bus using any of a variety of bus architectures.

Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer-readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more virtual processors, microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer-readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, virtual representations of physical core processors, or any combination thereof designed to perform the functions described herein. Further, processors can exploit nano-scale architectures, such as molecular and quantum-dot based transistors, switches, and gates, to optimize space usage or enhance the performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., C, C++, C #, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read-only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can be physical or virtual or a combination of both including the foregoing or other suitable types of memory.

Generally, a computing device will also include, or be operatively coupled to receive data from or transfer data to, or both, one or more mass data storage devices; however, a computing device need not have such devices. The computer-readable storage medium (or media) can be a tangible device that can retain and store instructions for use by an instruction execution device. The computer-readable storage medium can be, for example, an electronic storage device, a magnetic storage device, an optical storage device, an electromagnetic storage device, a semiconductor storage device, a virtual storage device, or any suitable combination of the foregoing. A non-exhaustive list of more specific examples of the computer-readable storage medium can include: a portable computer diskette, a hard disk, a random access memory (RAM), a read-only memory (ROM), an erasable programmable read-only memory (EPROM), flash memory, a static random access memory (SRAM), a portable compact disc read-only memory (CD-ROM), a digital versatile disk (DVD), a virtual memory component, a cloud memory component, a memory stick, a floppy disk, a mechanically encoded device such as punch-cards or raised structures in a groove having instructions recorded thereon, and any suitable combination of the foregoing.

In some embodiments, the steps and actions of the application instructions 140 described herein may be embodied directly in hardware, in a software module, such as programmable circuitry, an algorithm, a microcontroller, or the like, executed by a processor, virtualized representation of hardware, or in a combination of the three. A software module may reside in RAM, flash memory, ROM memory, EPROM memory, EEPROM memory, registers, a hard disk, a removable disk, a CD-ROM, virtualized memory, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a virtual or physical computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages. The application instructions 140 can execute entirely on the user's virtual or physical computer, partly on the user's computer, as a stand-alone software package, partly on the user's computer and partly on a remote computer, or partly on a virtual computer, or entirely on the remote computer or server or any combination thereof. In the latter scenario, the remote computer can be connected to the user's computer through any type of network, including a local area network (LAN) or a wide area network (WAN), a virtual private network (VPN), an enterprise private network (EPN), or the connection can be made to an external computer (for example, through the Internet using an Internet Service Provider or a Representational State Transfer API Endpoint (RESTful API endpoint)). In some embodiments, electronic circuitry including, for example, programmable logic circuitry, field-programmable gate arrays (FPGA), or programmable logic arrays (PLA) can execute the computer-readable program instructions by utilizing state information of the computer-readable program instructions to personalize the electronic circuitry, in order to perform aspects of the present disclosure.

In some embodiments, the application instructions 140 can be downloaded to a computing/processing device from a computer-readable storage medium, or to an external computer or external storage device via any type of network 190. A network adapter card or network interface in each computing/processing device receives computer readable program instructions from the network and forwards the computer readable application instructions 140 for storage in a computer-readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device-to-device Wi-Fi, Bluetooth, etc.), a Representational State Transfer API Endpoint (RESTful API endpoint), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher-level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of the medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network-attached storage, storage area networks, cloud storage, virtual storage, or any other medium that can be used to store the desired information and that can be accessed by a computing device.

In some embodiments, the system is world-wide-web (www) based, and the network server is a web server delivering HTML, XML, etc., web pages to the computing devices. In other embodiments, a client-server architecture may be implemented, in which a network server executes enterprise, Commercial Off The Shelf (COTS), and custom software, exchanging data with client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in” or “bot”) refers to computing instructions configured to extend the functionality of a computer program, where the add-on is developed specifically for the computer program. The term “add-on data” refers to data included with, generated by, or organized by an add-on. Computer programs can include computing instructions, configured systems, or an application programming interface (API) configured for communication between the computer program and an add-on.

In some embodiments, the computer system 100 may include a user device 145, an administrator computing device 185 and/or a third-party computing device 195 each in communication via the network 190. The administrator computing device 185 is utilized by an administrative user to moderate content and to perform other administrative functions. The third-party computing device 195 may be in communication with third-party users who are permitted to receive and/or transmit payor information, or other information including aggregated data with no identifiable patient info such as COVID patient numbers, how many discharged, deaths, how many on ventilators etc.

FIG. 2A illustrates a block diagram of a portion of the system architecture 200, according to some embodiments, including a core enterprise system 202 in operable communication with a claims module 204, provider module 206, contract management module 208, plan benefit administration module 210, member module 212, and encounter module 214. The block diagram illustrates information flow between each user and/or component of the system. Manual processes may result in a more errors or mistakes when reacting to changing regulations, providers, members, etc. For these reasons, the system provides an efficient enterprise payor digital platform that automates these processes and makes adapting to changing businesses and regulations easier. The system allows for payors to transition from fee-for-service to value-based care and comply with regulatory changes effecting payor operations. Further, the system provides member benefit plan entitlements, member Primary Care Physician (PCP) assignments, historical traceability of care delivery and pre-claims processing, fraud determinations and alerts, third party liabilities, coordination of benefits, and other payor functions.

The core enterprise system may function to provide multi-domain member master data management (MDM), health plan MDM, contract MDM, provider MDM, encounter MDM, and claims MDM, along with business rule handling. Any or all of the MDM modules within the core enterprise system may be in operable communication with one another to manage varying master data by bringing several data domains and processes into the core enterprise system as a central platform.

FIG. 2B illustrates a block diagram of a portion of the system architecture, according to some embodiments, including a member module 212. The member module may be configured to provide member support, eligibility and enrollment, assignment, relationship management, and workforce management by operably communicating with the core enterprise system. The member module may be configured to provide member support including call center workflow control and management along with workforce management. The member module may be configured to provide customer relationship management (CRM) with respect to members.

FIG. 2C illustrates a block diagram of a portion of the system architecture, according to some embodiments, including a plan benefit administration module 210 for managing plan products, including benefit management, plan reference code management, line of business plan management, and plan rate association development.

FIG. 2D illustrates a block diagram of a portion of the system architecture, according to some embodiments, including a contract management module 208 including contract management for physicians, nurses, surgical technicians, and ancillary providers. The contract management module 208 may provide for consolidated contract workflow and fee schedules.

FIG. 2E illustrates a block diagram of a contract module portion of the system architecture, according to some embodiments, including a provider module 206 for managing provider contracts and provider network agreements as well as provider data CRM workflow, credentialing CRM support, embedded or internal data capture, and facilities sites review. The provider module 206 may also provide physician and staff scheduling and provider relations and support.

FIG. 2F illustrates a block diagram of a portion of the system architecture, according to some embodiments including an encounters module 214 configured to provide electronic data interchange (EDI) processing. In some embodiments, the system includes provider (e.g., PCP, SPC, mid-level, and ancillary) processing. In some embodiments, the system provides encounter processing wherein the member interacts with a provider to generate an encounter.

FIGS. 2G and 2H illustrates a block diagram of a portion of the system architecture, according to some embodiments, including a core enterprise system 202 including a proprietary centralized core data management framework serviced by an intelligent data manager system components and computer programs. The core enterprise system may include application instructions embodied directly in hardware, in a software module, such as programmable circuitry, an algorithm, a microcontroller, or the like to integrate processes between providers and contract agreements, members and their benefit entitlements, clinical encounter submissions, and pre-claims management. This also allows for centralized interoperability between core data management functions.

FIGS. 2G and 2H illustrate a core enterprise system 202 providing for member MDM, health plan MDM, contract MDM, provider MDM, encounter MDM, and claims MDM, along with business rule handling. The core enterprise system 202 may also provide for unstructured data management and inbound EDI.

FIG. 2I illustrates a block diagram of a portion of the system architecture, according to some embodiments including a claims module 204. The claims processing provides a means for paying and reconciling the provider and member reimbursements for the paid claim. A subsequent claim is produced and submitted for payment.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer-readable program instructions can be provided to a processor of a general-purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer-readable program instructions can be stored in a computer-readable storage medium that can direct a computer, a programmable data processing apparatus, and/or other devices to function in a particular manner, such that the computer-readable storage medium having instructions and data stored therein comprises an article of manufacture including instructions which implement aspects of the function/act specified in the flowchart and/or block diagram block or blocks. The computer-readable program instructions and data can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implements the functions or acts as specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, data, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carries out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, cloud computing systems, virtual computing systems, as well as computers, bots, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,”” framework,” and the like, can refer to and/or include a computer-related entity or an entity related to an operational machine with one or more specific functionalities. The disclosed entities can be physical hardware, cloud hardware, virtual hardware, or a combination of cloud hardware, virtual hardware, physical hardware, and software or software in

execution. For example, a component can be a process running on a processor, a dedicated processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer-readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be any apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as software applications, software programs, database managers, internet browsers, and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” or API are used herein to mean a set of commands, functions and/or protocols that computer programmers can use when building software for a specific application framework and system's operating environment. The API allows programmers to use predefined functions to interact with an application framework and system's operating environment instead of writing software from scratch. Common computer application frameworks and operating systems, including AWS, Azure, Windows, Unix, and Mac OS, usually provides APIs for programmers. APIs are also used by physical and virtual hardware devices that run software programs. APIs generally ensure that all programs using the same API will have similar integration capabilities.

The phrase “central processing unit” as is used herein means a computer physical and/or virtual hardware components that execute individual commands of a computer software program. It reads program instructions from a main or secondary memory, and then executes the instructions until the program ends. During execution, the program may display information to an output device such as a monitor.

The term “execute” as is used herein in connection with a computer, console, server system or the like means to run, use, operate or carry out an instruction, code, software, program and/or the like.

The following description of variants is only illustrative of components, elements, acts, product, and methods considered to be within the scope of the invention and are not in any way intended to limit such scope by what is specifically disclosed or not expressly set forth. The components, elements, acts, product, and methods as described herein may be combined and rearranged other than as expressly described herein and still are considered to be within the scope of the invention.

According to variation 1, a system for providing a platform for automating healthcare insurance administration may include at least one user computing device in operable connection with a user network; and an application server in operable communication with the user network, the application server configured to host an application system for providing a platform for automating healthcare insurance administration, the application system having a user interface for providing access to the application system through the at least one user computing device.

Variation 2 may include a system for providing a platform for automating healthcare insurance administration as in variation 1, wherein the application server is configured to host an application system for providing a platform that automates a payors transition from a fee-for-service to a value-based care while complying with regulatory changes effecting payor

Variation 3 may include a system for providing a platform for automating healthcare insurance administration as in variations 1 or 2, further including a database for storing healthcare insurance information associated with at least one user, including at least one of variations, policies, or payment information, wherein the database is accessible by authorized healthcare providers and insurance companies for processing variations and payments.

Variation 4 may include a system for providing a platform for automating healthcare insurance administration as in any of variations 1 through 3, including a core enterprise system in operable communication with a user network, where the core enterprise system is configured to provide at least one of a multi-domain member MDM, health plan MDM, contract MDM, provider MDM, encounter MDM, variations MDM, or business rule handling.

Variation 5 may include a system for providing a platform for automating healthcare insurance administration as in any of variations 1 through 4, including a variations module configured to provide for paying and reconciling a provider and at least one member reimbursement for a paid variation.

Variation 6 may include a system for providing a platform for automating healthcare insurance administration as in any of variations 1 through 5, including a provider module configured to provide at least one of provider contracts management, provider network agreement management, provider data CRM workflow, credentialing CRM support, embedded or internal data capture, or facilities sites review.

Variation 7 may include a system for providing a platform for automating healthcare insurance administration as in any of variations 1 through 6, including a contract management module configured to provide at least one of contract management for physicians, nurses, surgical technicians, or ancillary providers.

Variation 8 may include a system for providing a platform for automating healthcare insurance administration as in any of variations 1 through 7, including a plan benefit administration module configured to provide at least one of plan products management, benefit management, plan reference code management, line of business plan management, or plan rate association development.

Variation 9 may include a system for providing a platform for automating healthcare insurance administration as in any of variations 1 through 8, including a member module configured to provide at least one of member support, eligibility and enrollment, assignment, call center workflow control, relationship management, customer relationship management, or workforce management.

Variation 10 may include a system for providing a platform for automating healthcare insurance administration as in any of variations 1 through 9, including an encounter module configured to provide at least one of EDI processing, provider processing, or encounter processing.

According to variation 11, a computer program product may include an application server including a core enterprise system in operable communication with a user network; a variations module; a provider module; a contract management module; a plan benefit administration module; a member module; and an encounter module.

Variation 12 may include a computer program product as in variation 11, wherein the application server is configured to host an application system for providing a platform that automates a payors transition from a fee-for-service to a value-based care while complying with regulatory changes effecting payor operations.

Variation 13 may include a computer program product as in variation 11 or 12, further including a database for storing healthcare insurance information associated with at least one user, including at least one of variations, policies, or payment information, wherein the database is accessible by authorized healthcare providers and insurance companies for processing variations and payments.

Variation 14 may include a computer program product as in any of variations 11 through 13, wherein the core enterprise system is configured to provide at least one of a multi-domain member MDM, health plan MDM, contract MDM, provider MDM, encounter MDM, variations MDM, or business rule handling.

According to variation 15, a method of automating healthcare insurance administration, may include hosting an application system for providing a platform for automating healthcare insurance administration on a network, the application system including a core enterprise system configured to provide at least one of a multi-domain member MDM, health plan MDM, contract MDM, provider MDM, encounter MDM, variations MDM, or business rule handling; and providing access to the application system via a user interface accessible through at least one user computing device.

Variation 16 may include a method of automating healthcare insurance administration as in variation 15, wherein the application system is configured to host an application system for providing a platform that automates a payors transition from a fee-for-service to a value-based care while complying with regulatory changes effecting payor

Variation 17 may include a method of automating healthcare insurance administration as in variations 15 or 16, wherein the application system is in operable communication with a database for storing healthcare insurance information associated with at least one user, including at least one of variations, policies, or payment information, wherein the database is accessible by authorized healthcare providers and insurance companies for the purpose of processing variations and payments.

Variation 18 may include a method of automating healthcare insurance administration as in any of variations 15 through 17, wherein the application system is in operable communication with a core enterprise system in operable communication with a user network, where the core enterprise system is configured to provide at least one of a multi-domain member MDM, health plan MDM, contract MDM, provider MDM, encounter MDM, variations MDM, or business rule handling.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for providing a platform for automating healthcare insurance
administration, the system comprising:
at least one user computing device in operable connection with a user network; and
an application server in operable communication with the user network, the application server configured to host an application system for providing a platform for automating healthcare insurance administration, the application system having a user interface for providing access to the application system through the at least one user computing device.

2. The system for providing a platform for automating healthcare insurance administration as in claim 1, wherein the application server is configured to host an application system for providing a platform that automates a payors transition from a fee-for-service to a value-based care while complying with regulatory changes effecting payor operations.

3. The system for providing a platform for automating healthcare insurance administration as in claim 2, further comprising:
a database for storing healthcare insurance information associated with at least one user, including at least one of claims, policies, or payment information, wherein the database is accessible by authorized healthcare providers and insurance companies for processing claims and payments.

4. The system for providing a platform for automating healthcare insurance administration as in claim 3, comprising:
a core enterprise system in operable communication with a user network, where the core enterprise system is configured to provide at least one of a multi-domain member MDM, health plan MDM, contract MDM, provider MDM, encounter MDM, claims MDM, or business rule handling.

5. The system for providing a platform for automating healthcare insurance administration as in claim 1, comprising:
a claims module configured to provide for paying and reconciling a provider and at least one member reimbursement for a paid claim.

6. The system for providing a platform for automating healthcare insurance administration as in claim 1, comprising:
a provider module configured to provide at least one of provider contracts management, provider network agreement management, provider data CRM workflow, credentialing CRM support, embedded or internal data capture, or facilities sites review.

7. The system for providing a platform for automating healthcare insurance administration as in claim 1, comprising:
a contract management module configured to provide at least one of contract management for physicians, nurses, surgical technicians, or ancillary providers.

8. The system for providing a platform for automating healthcare insurance administration as in claim 1, comprising:
a plan benefit administration module configured to provide at least one of plan products management, benefit management, plan reference code management, line of business plan management, or plan rate association development.

9. The system for providing a platform for automating healthcare insurance administration as in claim 1, comprising:
a member module configured to provide at least one of member support, eligibility and enrollment, assignment, call center workflow control, relationship management, customer relationship management, or workforce management.

10. The system for providing a platform for automating healthcare insurance administration as in claim 1, comprising:
an encounter module configured to provide at least one of EDI processing, provider processing, or encounter processing.

11. A computer program product, comprising:
an application server comprising a core enterprise system in operable communication with a user network;
a claims module;
a provider module;
a contract management module;
a plan benefit administration module;
a member module; and
an encounter module.

12. The computer program product as in claim 11, wherein the application server is configured to host an application system for providing a platform that automates a payors transition from a fee-for-service to a value-based care while complying with regulatory changes effecting payor operations.

13. The computer program product as in claim 11, further comprising:
a database for storing healthcare insurance information associated with at least one user, including at least one of claims, policies, or payment information, wherein the database is accessible by authorized healthcare providers and insurance companies for processing claims and payments.

14. The computer program product as in claim 11, wherein the core enterprise system is configured to provide at least one of a multi-domain member MDM, health plan MDM, contract MDM, provider MDM, encounter MDM, claims MDM, or business rule handling.

15. A method of automating healthcare insurance administration, comprising:
hosting an application system for providing a platform for automating healthcare insurance administration on a network, the application system comprising a core enterprise system configured to provide at least one of a multi-domain member MDM, health plan MDM, contract MDM, provider MDM, encounter MDM, claims MDM, or business rule handling; and
providing access to the application system via a user interface accessible through at least one user computing device.

16. The method of automating healthcare insurance administration, as in claim 15, wherein the application system is configured to host an application system for providing a platform that automates a payors transition from a fee-for-service to a value-based care while complying with regulatory changes effecting payor operations.

17. The method of automating healthcare insurance administration, as in claim 15, wherein the application system is in operable communication with a database for storing healthcare insurance information associated with at least one user, including at least one of claims, policies, or payment information, wherein the database is accessible by authorized healthcare providers and insurance companies for the purpose of processing claims and payments.

18. The method of automating healthcare insurance administration, as in claim 15, wherein the application system is in operable communication with a core enterprise system in operable communication with a user network, where the core enterprise system is configured to provide at least one of a multi-domain member MDM, health plan MDM, contract MDM, provider MDM, encounter MDM, claims MDM, or business rule handling.
